(19) United States
(12) Patent Application Publication
(10) Pub. No.: US 2026/0100476 A1
(43) Pub. Date: Apr. 9, 2026

(54) FIRE EXTINGUISHING AGENT STRUCTURE AND SECONDARY BATTERY INCLUDING THE FIRE EXTINGUISHING AGENT STRUCTURE

(71) Applicant: SAMSUNG SDI CO., LTD., Yongin-si (KR)

(72) Inventor: Sang Hyo LEE, Yongin-si (KR)

(21) Appl. No.: 19/307,232

(22) Filed: Aug. 22, 2025

(30) Foreign Application Priority Data
Oct. 8, 2024 (KR) 10-2024-0136707

(51) Int. Cl. H01M 50/383; A62D 1/00; A62D 1/06; H01M 10/613

(52) U.S. Cl. CPC H01M 50/383; A62D 1/0021; A62D 1/06; H01M 10/613

(57) ABSTRACT

The present disclosure relates to a secondary battery including a fire extinguishing agent structure. The fire extinguishing agent structure includes a disk-shaped member and a stick-shaped member connected to and extending perpendicular to the disk-shaped member. The stick-shaped member and the disk-shaped member include a fire extinguishing agent that causes an endothermic reaction at a temperature of 100 °C or higher.

### CROSS-REFERENCE TO RELATED APPLICATION

The present application claims priority to and the benefit of Korean Patent Application No. 10-2024-0136707, filed on October 8, 2024, in the Korean Intellectual Property Office, the entire disclosure of which is incorporated herein by reference.

### BACKGROUND

### 1. Field of the Disclosure

The present disclosure relates to a fire extinguishing agent structure and a secondary battery including the fire extinguishing agent structure.

### 2. Discussion of Related Art

With the rapid spread of electronic devices that use batteries, such as cellular phones, laptop computers and electric vehicles, the demand for secondary batteries with high energy density and high capacity has rapidly increased. Accordingly, there is active research and development to improve the performance of lithium secondary batteries.

A lithium secondary battery includes a positive electrode and a negative electrode, both of which contain active materials capable of intercalation and deintercalation of lithium ions, and an electrolyte. A lithium secondary battery generates electrical energy through oxidation and reduction reactions when lithium ions are intercalated/deintercalated into/from the positive electrode and the negative electrode.

The information disclosed in this section is only for improving the understanding of the background of the present disclosure and may include information that does not constitute the related or prior art.

### SUMMARY OF THE DISCLOSURE

The present disclosure is directed to providing a fire extinguishing agent structure with stability by preventing thermal runaway at high temperatures and a secondary battery including the fire extinguishing agent structure.

However, the technical problems to be solved by the present disclosure are not limited to the above-described problems, and other problems and solutions provided by the present disclosure not mentioned will be clearly understood by those skilled in the art from the following description.

A fire extinguishing agent structure according to embodiments of the present disclosure includes a disk-shaped member; and a stick-shaped member connected to and extending perpendicular to the disk-shaped member, wherein the stick-shaped member and the disk-shaped member include a fire extinguishing agent that causes an endothermic reaction at a temperature of 100 °C or higher.

In order to overcome the above-described technical problem, a secondary battery according to the present disclosure includes an electrode assembly; a case accommodating the electrode assembly; a cap assembly electrically connected to the electrode assembly; a disk-shaped member positioned between the electrode assembly and the cap assembly; and a stick-shaped member connected to and extending perpendicular to the disk-shaped member and inserted into a core of the electrode assembly, wherein the disk-shaped member and the stick-shaped member include a fire extinguishing agent that causes an endothermic reaction at a temperature of 100 °C or higher.

### BRIEF DESCRIPTION OF THE DRAWINGS

The drawings attached to this specification illustrate exemplary embodiments of the present disclosure and along with the following detailed description serve to help understand the the present disclosure. The present disclosure should not be construed as limited to the matters described in the drawings.

FIG. 1 is a perspective view of a fire extinguishing agent structure according to an embodiment of the present disclosure;

FIG. 2 is a cross-sectional view of a fire extinguishing agent structure according to an embodiment of the present disclosure;

FIG. 3 is a plan view of a fire extinguishing agent structure according to an embodiment of the present disclosure;

FIG. 4 is a perspective view of a secondary battery according to an embodiment of the present disclosure;

FIG. 5 is a cross-sectional view of a secondary battery according to an embodiment of the present disclosure;

FIG. 6 is a perspective view of a battery pack according to an embodiment of the present disclosure; and

FIG. 7 is a plan view of a battery pack according to an embodiment of the present disclosure.

### DETAILED DESCRIPTION OF EXEMPLARY EMBODIMENTS

Hereinafter, preferred embodiments of the present disclosure will be described in detail with reference to the attached drawings. Terms or words used in this specification and claims should not be construed as limited to their conventional or dictionary meanings but should be construed as a meaning and concept consistent with the technical idea of the present disclosure based on the principle that the inventors can properly define the concept of terms in order to describe their invention in the best way. Therefore, the embodiments described in this specification and the configurations shown in the drawings are only some of the most preferred embodiments of the present disclosure and do not represent the entire technical idea of the present disclosure, and thus it should be understood that there may be various equivalents and modifications that can replace them at the time of filing this application.

When used herein, the term “comprise or include” and/or “comprising or including” specify the presence of the mentioned shapes, numbers, steps, operations, members, elements and/or groups thereof, and do not exclude the presence or addition of one or more other shapes, numbers, operations, members, elements and/or groups.

In order to help understand the present disclosure, the attached drawings are not drawn to scale, and the dimensions of some components may be exaggerated. In addition, the same reference numbers may be assigned to the same components in different embodiments.

The statement that two objects for comparison are “the same” means that the two are “substantially the same.” Therefore, “substantially the same” may include a deviation that is considered low in the art, for example, a deviation of less than 5%. Additionally, uniformity of a parameter in a certain area may be the uniformity from an average perspective.

Although the terms “first,” “second,” etc. are used to describe various components, these components are not limited thereto. These terms are used to distinguish one component from another component, and unless specifically stated to the contrary, a first component may be a second component.

Throughout the specification, unless otherwise stated, each component may be singular or plural.

When any component is said to be disposed on the “upper surface (or lower surface)” of a component or “on (or under)” a component, this not only means that any component is disposed in contact with the upper (or lower) surface of the component, but also means that other components may be interposed between the component and any component disposed on (or under) the component.

When a component is described as being “on,” “connected to,” or “coupled to” another component, the components may be directly connected or linked to each other, but it should be understood that other components may be “interposed” between each component, or that each component may be “connected,” “coupled,” or “linked” through other components.

As used herein, the term “and/or” includes any and all combinations of one or more of the associated listed items. Also, when describing embodiments of this disclosure, the use of “may” refers to “one or more embodiments of this disclosure.” Phrases such as “one or more” and “at least one” before a list of elements modify the entire list of elements and do not modify the individual elements of the list.

In the specification, “A and/or B” means A, B, or A and B, unless specifically stated to the contrary, and “C to D” means C or more and D or less, unless specifically stated to the contrary.

When phrases such as “at least one of A, B, and C,” “at least one of A, B, or C,” “at least one selected from the group of A, B, and C,” or “at least one selected from A, B, and C” are used to specify a list of elements A, B, and C, the phrase can refer to any and all suitable combinations.

The term “use” can be considered synonymous with the term “utilize.” As used herein, terms such as “substantially” and “about” and similar terms are used as terms of approximation rather than terms of degree, and are intended to account for the inherent variations in measured or calculated values that would be recognized by those of ordinary skill in the art.

In this specification, terms such as “first,” “second,” “third,” etc. may be used to describe various elements, components, regions, layers, and/or sections. However, these elements, components, regions, layers, and/or sections should not be limited thereto. These terms are used to distinguish one element, component, region, layer, or section from another element, component, region, layer, or section. Therefore, a first element, component, region, layer, or section discussed below may be called a second element, component, region, layer, or section without departing from the teachings of the exemplary embodiments.

Spatial relative terms such as “beneath,” “below,” “lower,” “above,” “upper,” etc. may be used herein to explain the relationship between one element or feature and another element(s) or feature(s) as illustrated in the drawings for ease of description. It should be understood that the spatially relative positions are intended to encompass different orientations of the device in use or operation, in addition to the orientations described in the figures. For example, when the device in the drawing is turned over, elements described as “below” or “beneath” other elements would be oriented “above” or “on” the other elements. Thus, the term “below” may encompass both above and below directions.

The terms used in this specification are for describing embodiments of the present disclosure and are not intended to limit the present disclosure.

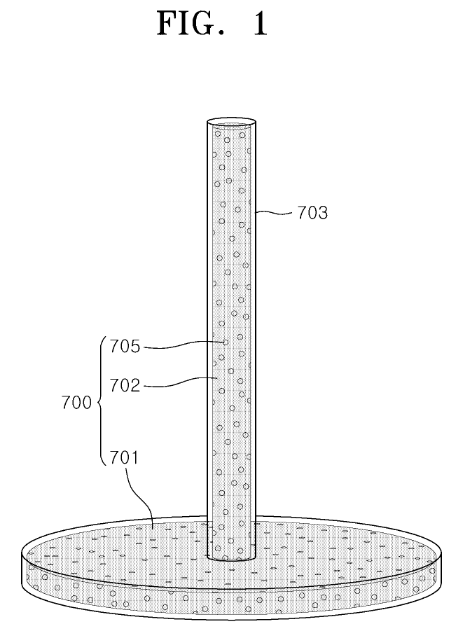

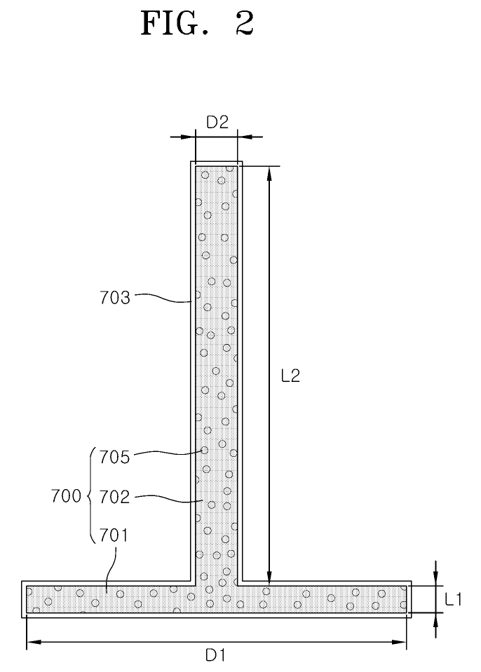

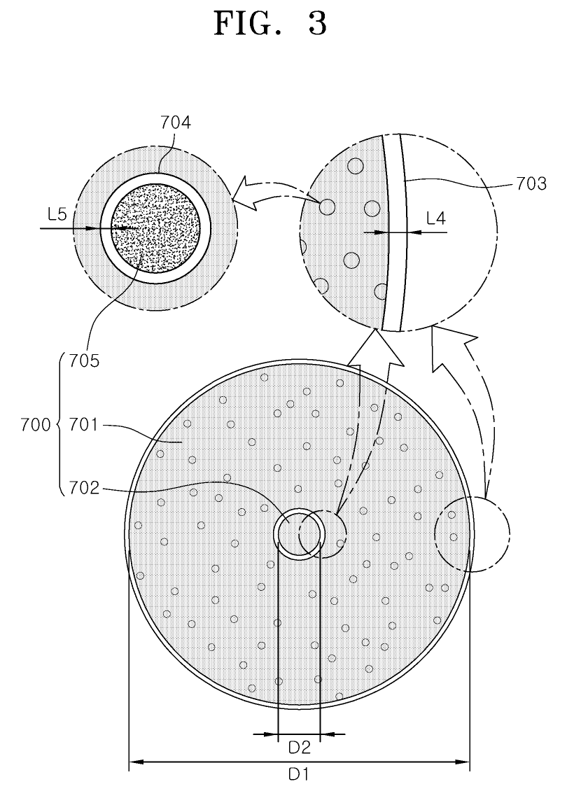

FIG. 1 is a perspective view of a fire extinguishing agent structure according to an embodiment of the present disclosure, FIG. 2 is a cross-sectional view schematically illustrating the configuration of a fire extinguishing agent structure according to an embodiment of the present disclosure, and FIG. 3 is a plan view of a fire extinguishing agent structure according to an embodiment of the present disclosure.

Referring to FIGS. 1 to 3, a fire extinguishing agent structure 700 according to the present disclosure includes a disk-shaped member 701, a stick-shaped member 702, and a fire extinguishing agent 705.

When the internal temperature of the battery rises due to internal short circuits, overcharging, exposure to high temperatures, or Joule's heating, secondary batteries can undergo a self-heating reaction in which heat generation is rapidly accelerated upon reaching a certain temperature. When a chain reaction accelerating the self-heating reaction progresses, the internal temperature of the battery rises rapidly, exceeding the critical point of thermal runaway. In such a situation, an explosion or fire may occur. When the fire extinguishing agent 705 is contained in microcapsules 704, it is easy to cool the internal temperature of the battery near the critical point of thermal runaway, which may be advantageous in preventing thermal runaway. In other words, the fire extinguishing agent 705 helps reduce the possibility of chain reactions at high temperatures by lowering the peak of self-heating. Stability and reliability of the battery may be achieved by preventing the critical point of thermal runaway from being exceeded.

The fire extinguishing agent 705 causes an endothermic reaction at a temperature of 100 °C or higher. In a specific example, the internal temperature of the battery may be lowered through a material that undergoes phase transformation based on the critical temperature. Alternatively, in another specific example, a gas that can extinguish a fire may be generated through thermal decomposition at a temperature of 100 °C to 150 °C, for example, 100 °C to 130 °C.

The fire extinguishing agent 705 may be one or more selected from sodium bicarbonate (NaHCO₃), potassium bicarbonate (KHCO₃), manganese carbonate (MnCO₃), and ammonium dihydrogen phosphate (NH₄H₂PO₄). But the present disclosure is not limited thereto. Sodium bicarbonate (NaHCO₃) and potassium bicarbonate (KHCO₃) may undergo an endothermic reaction during high-temperature decomposition in which they change to anhydrous sodium carbonate (Na₂CO₃) and anhydrous potassium carbonate (K₂CO₃), respectively. At this time, carbon dioxide (CO₂) and water (H₂O) may be generated to lower the battery temperature, and it is possible to suffocate a fire by blocking the supply of oxygen. Manganese carbonate (MnCO₃) generates an inert gas when it changes to manganese (II) oxide (MnO) during high-temperature decomposition. And with such a decomposition is possible to suffocate by generating carbon dioxide. Ammonium dihydrogen phosphate (NH₄H₂PO₄) changes to phosphoric acid (H₃PO₄) during thermal decomposition, causing an endothermic reaction that may cool combustible materials and generating phosphoric acid compounds to remove flammable substances.

The fire extinguishing agent 705 may be a powder, liquid, or gas material. In a specific example, when the internal temperature of the battery is high, the powder material changes into a liquid when reaching its melting point, thereby causing an endothermic reaction and lowering the temperature. Alternatively, the fire extinguishing agent 705 may be discharged in powder form to inhibit or delay the thermal runaway reaction of the cell. In a specific example, when the internal temperature of the battery is high, the liquid material changes into gas and causes an endothermic reaction, thereby lowering the temperature inside the battery. In a specific example, the gas phase material may reduce the concentration of combustible gases, thereby reducing the self-heating chain reaction.

In some embodiments, the fire extinguishing agent 705 may be contained in microcapsules 704. The microcapsules 704 may melt at a temperature of 100 °C or higher and discharge the fire extinguishing agent 705 contained therein. When the internal temperature of the battery is high, the shell of the microcapsule 704 is destroyed, and, thus, the fire extinguishing agent 705 is discharged. This reduces the risk of ignition or explosion of the battery.

A method of manufacturing the microcapsule 704 is not particularly limited as long as the microcapsules contain the fire extinguishing agent 705. In a specific example, there is a microencapsulation method that includes mixing a phase change material and a material that can be used as the capsule shell, emulsifying the mixture, forming capsules by having the capsule shell surround the phase change material dispersed as liquid droplets, curing, and drying the capsules. Alternatively, there is another encapsulation method in which a core-shell structure is formed through emulsification or polymerization reactions of core and shell materials.

The diameter (D3) of the microcapsules 704 may be 10 μm to 30 μm. In a specific example, the diameter (D3) may be 12 μm to 28 μm, for example, 15 μm to 25 μm. Within this range the microcapsules 704 have a large surface area, and it is therefore possible to detect temperature changes quickly and significantly, increase the efficiency of the endothermic reaction of the fire extinguishing agent 705, and help prevent thermal runaway.

The microcapsules 704 may have a shell thickness (L5) of 0.5 μm to 10 μm. In a specific example, the thickness (L5) may be 1 μm to 9 μm, for example, 2 μm to 8 μm. Within this range, it is easy to melt the microcapsules, which may be advantageous in preventing thermal runaway.

The shells of the microcapsules 704 may include materials that are advantageous for containing and sealing the fire extinguishing agent 705, do not react with the fire extinguishing agent 705, and easily melt at high temperatures. In a specific example, the shell material may be one or more of epoxy, silicone, acrylate, and polyurea and polyurethane based on polyisocyanate prepolymers. But the present disclosure is not limited to these examples.

The disk-shaped member 701 according to the present embodiment includes the fire extinguishing agent 705 and may be seated between an electrode assembly and a cap assembly. The disk-shaped member 701 may have a diameter (D1) of 30 mm to 45 mm. In a specific example, the diameter (D1) may be 32 mm to 43 mm, for example, 35 mm to 42 mm. The disk-shaped member 701 may have a thickness (L1) of 1.0 mm to 5.0 mm. In a specific example, the thickness (L1) may be 1.2 mm to 4.8 mm, for example, 2.0 mm to 4.0 mm. Within these ranges, the efficiency of the endothermic reaction of the fire extinguishing agent 705 may be increased and thermal runaway may be prevented.

The stick-shaped member 702 according to the present embodiment is vertically coupled to the disk-shaped member 701. The stick-shaped member 702 may be inserted into the core of a wound electrode assembly. The stick-shaped member 702 may have a diameter (D2) of 3 mm to 6 mm. In a specific example, the diameter (D2) may be 3.5 mm to 5.2 mm, for example, 4.0 mm to 4.8 mm. Within this range, the efficiency of the endothermic reaction of the fire extinguishing agent may be increased thermal runaway may be prevented.

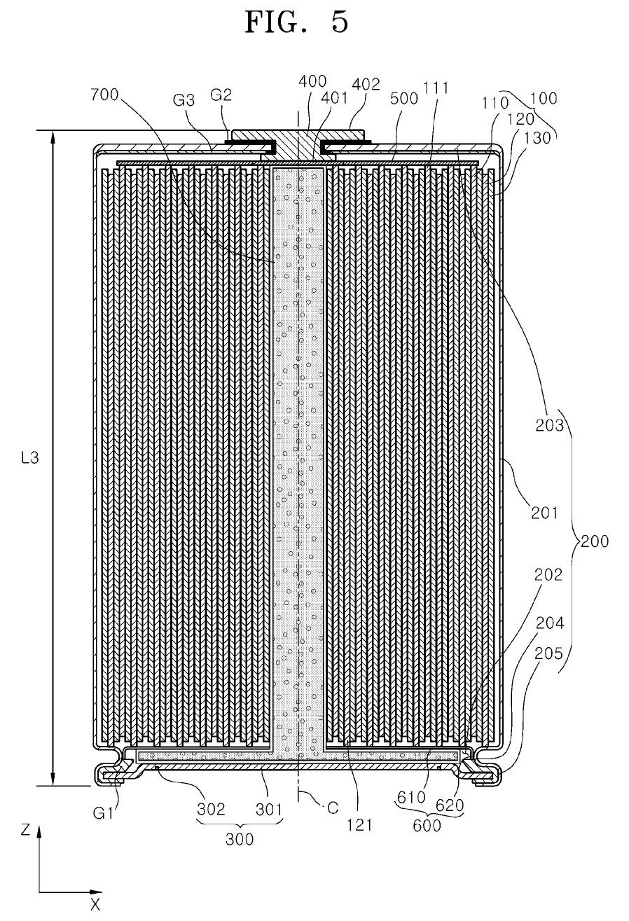

The length (L2) of the stick-shaped member 702 may be 0.55 to 0.96 with respect to the overall battery height (L3). Referring to FIG. 5, the overall battery height (L3) may be defined as the distance from a second terminal surface 402 of a terminal 400 to the bottom surface of the crimping portion 205. In a specific example, the length (L2) of the stick-shaped member 702 relative to the overall battery height (L3) may be 0.6 to 0.95, for example, 0.7 to 0.95. Within this range, the efficiency of the endothermic reaction of the fire extinguishing agent may be increased and thermal runaway may be prevented.

The disk-shaped member 701 and the stick-shaped member 702 may be integrally formed. The fire extinguishing agent structure 700 formed as an integrated component has higher strength and durability against external impacts, and may have a simplified structure.

The disk-shaped member 701 and the stick-shaped member 702 may include a polymeric cover member 703. The polymeric cover member 703 may melt or rupture at a temperature of 100 °C or higher, thereby releasing the fire extinguishing agent 705 contained in a plurality of microcapsules 704 and preventing thermal runaway. The polymeric cover member 703 may have a thickness (L4) of 50 μm to 100 μm. In a specific example, the thickness (L4) may be 60 μm to 90 μm, for example, 70 μm to 85 μm. Within this range, the polymeric cover member 703 easily melts or ruptures, which is advantageous in preventing thermal runaway.

The material of the polymeric cover member 703 accommodates and seals a plurality of microcapsules 704 and may include a material that may easily melt or rupture at a temperature of 100 °C or higher. In a specific example, material may be one or more of polyethylene (PE), polypropylene (PP), polyimide (PI), polyethylene terephthalate (PET), epoxy, acetal, indium, and polyurea and polyurethane based on polyisocyanate prepolymers. But the present disclosure is not limited to these examples.

The disk-shaped member 701 and the stick-shaped member 702 may be filled with a plurality of microcapsules 704 containing the fire extinguishing agent. The microcapsules may be compression-molded into pellets in the shape of a disk or stick and provided into the secondary battery without the polymeric cover member. The pellets melt or rupture at a temperature of 100 °C or higher, thereby releasing the fire extinguishing agent 705 contained in the plurality of microcapsules 704 and preventing thermal runaway.

The volume of the plurality of microcapsules 704 may be 60% to 90% of the total volume of the fire extinguishing agent structure 700. In a specific example, the volume may be 65% to 85%, for example, 70% to 80%. Within this range, the efficiency of the endothermic reaction of the fire extinguishing agent may be increased and thermal runaway may be prevented.

The disk-shaped member 701 and the stick-shaped member 702 may be formed from a composition including a plurality of microcapsules and a binder. In a specific example, the plurality of microcapsules 704 are dispersed in the binder. The binder may be one or more of polyvinylidene fluoride, styrene-butadiene rubber, acrylated styrene-butadiene rubber, acrylonitrile-butadiene rubber, acrylonitrile-butadiene-styrene rubber, acrylic rubber, butyl rubber, a fluoroelastomer, polytetrafluoroethylene, polyethylene, polypropylene, an ethylene-propylene copolymer, polyethylene oxide, polyvinyl pyrrolidone, polyepichlorohydrin, polyphosphazene, polyacrylonitrile, polystyrene, an ethylene-propylene-diene copolymer, polyvinyl pyridine, chlorosulfonated polyethylene, latex, a polyester resin, an acrylic resin, a phenolic resin, an epoxy resin, polyvinyl alcohol, hydroxypropyl methylcellulose, hydroxypropyl cellulose, and diacetyl cellulose. But the present disclosure it is not limited to these examples.

The binder may be included in an amount of 50 parts by weight to 80 parts by weight based on 100 parts by weight of the microcapsules. In a specific example, the binder may be included in an amount of 60 parts by weight to 80 parts by weight, for example, 60 parts by weight to 75 parts by weight. Within these ranges, the efficiency of the endothermic reaction of the fire extinguishing agent may be increased thermal runaway may be prevented.

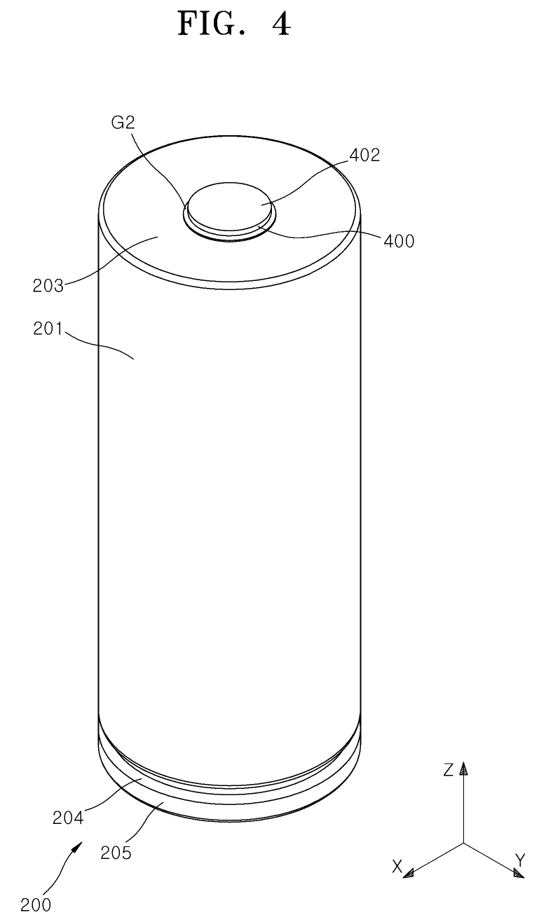

FIG. 4 is a perspective view of a secondary battery according to an embodiment of the present disclosure, and FIG. 5 is a cross-sectional view of a secondary battery according to an embodiment of the present disclosure.

Referring to FIGS. 4 and 5, a secondary battery 2 includes an electrode assembly 100, a case 200, a cap assembly 300, a terminal 400, a first current collector 500, and a fire extinguishing agent structure 700. Hereinafter, the secondary battery will be described as a cylindrical lithium-ion secondary battery. However, the present disclosure is not limited thereto, and in other embodiments the secondary battery may be, for example, a lithium polymer battery or a prismatic battery.

The electrode assembly 100 according to the present embodiment may serve as a unit structure that performs the charging and discharging operations of the secondary battery. The electrode assembly 100 may include a first electrode plate 110, a second electrode plate 120, and a separator 130 disposed between the first electrode plate 110 and the second electrode plate 120.

The electrode assembly 100 may be wound around a winding axis C. More specifically, the electrode assembly 100 may be formed by stacking the first electrode plate 110, separator 130, and second electrode plate 120 and winding the stacked structure around the winding axis C in a clockwise or counterclockwise direction. As such, the electrode assembly 100 may have a jelly roll shape. In addition to circular, the cross-sectional shape of the electrode assembly 100 may be other shapes such as oval, polygonal, and the like. Here, the winding axis C may refer to a straight line passing through the center of the electrode assembly 100.

The first electrode plate 110 may function as a positive electrode of the electrode assembly 100. The first electrode plate 110 may be a foil that includes a metal material such as aluminum or an aluminum alloy. The first electrode plate 110 is not limited in terms of its type, size, and shape as long as it has conductivity and does not cause chemical changes in the secondary battery.

A first active material layer may be applied to at least a portion of the first electrode plate 110. The first active material layer may be applied to both sides of the first electrode plate 110, or applied to only one side of the first electrode plate 110.

As the first electrode plate 110 serves as a positive electrode, the first active material layer may include a positive electrode active material. A compound capable of reversible intercalation and deintercalation of lithium (lithiated intercalation compound) may be used as a positive electrode active material. Specifically, one or more types of composite oxides of lithium and a metal selected from cobalt, manganese, nickel, iron, and a combination thereof may be used. For example, the positive electrode active material may include at least one of lithium iron phosphate oxide (LiFePO₄, LFP), lithium manganese iron phosphate oxide (LiMnFePO₄, LMFP), and lithium nickel cobalt manganese oxide (LiNiₓCo_{y}Mn_{z}O₂, NCM). Here, 0<x<1, 0<y<1, 0<z<1, and x+y+z=1 may be satisfied. The positive electrode active material may include one or more of lithium iron phosphate oxide (LiFePO₄, LFP), lithium manganese iron phosphate oxide (LiMnFePO₄, LMFP), and lithium nickel cobalt manganese oxide (LiNiₓCo_{y}Mn_{z}O₂, NCM).

The first active material layer may further include a positive electrode conductive material. The positive electrode conductive material is used to impart conductivity to the first active material layer, and any material may be used as the positive electrode conductive material as long as it does not cause chemical changes and is electronically conductive. Examples of positive electrode conductive material may include carbon-based materials such as natural graphite, artificial graphite, carbon black, acetylene black, Ketjen black, carbon fibers, carbon nanofibers, and carbon nanotubes, metal-based materials in the form of metal powder or metal fibers containing copper, nickel, aluminum, silver, etc., conductive polymers such as polyphenylene derivatives, or a mixture thereof.

The first active material layer may further include a positive electrode binder. The positive electrode binder adheres the particles constituting the positive electrode active material to each other and also to adheres the positive electrode active material to the first electrode plate 110. The positive electrode binder may be, for example, a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When an aqueous binder is used as the positive electrode binder, it may further include a cellulose-based compound capable of imparting viscosity. As the cellulose-based compound, a mixture of one or more of carboxymethyl cellulose, hydroxypropylmethyl cellulose, methyl cellulose, or alkali metal salts thereof may be used. As the alkali metal, Na, K, or Li may be used.

A dry binder is a polymer material capable of being fiberized, and may be, for example, polytetrafluoroethylene, polyvinylidene fluoride, a polyvinylidene fluoride-hexafluoropropylene copolymer, polyethylene oxide, or a combination thereof.

The first electrode plate 110 may include a first uncoated portion 111 where the first active material layer is not applied. The first uncoated portion 111 may protrude a predetermined distance from a first end of the electrode assembly 100 in the direction of the winding axis C.

The second electrode plate 120 may function as a negative electrode of the electrode assembly 100. The second electrode plate 120 may be a foil that includes a metal material such as copper, a copper alloy, nickel, or a nickel alloy. The second electrode plate 120 may be disposed to face the first electrode plate 110 at a predetermined distance. The second electrode plate 120 is not limited in terms of its type, size, and shape, as long as it has conductivity and does not cause chemical changes in the secondary battery.

A second active material layer may be applied to at least a portion of the second electrode plate 120. The second active material layer may be applied to both sides of the second electrode plate 120, or applied to only one side of the second electrode plate 120. As the second electrode plate 120 serves as a negative electrode, the second active material layer may include a negative electrode active material. The negative electrode active material may include a material capable of reversibly intercalating/deintercalating lithium ions, lithium metal, an alloy of lithium and a metal and a material capable of doing and dedoping lithium, or a transition metal oxide.

The material capable of reversibly intercalating/deintercalating lithium ions is a carbon-based negative electrode active material and may include, for example, crystalline carbon, amorphous carbon, or a combination thereof. Examples of the crystalline carbon include graphite such as amorphous, platy, flaky, spherical, or fibrous natural graphite or artificial graphite. Examples of the amorphous carbon include soft carbon, hard carbon, mesophase pitch carbide, calcined coke, and so on.

The alloy of lithium and a metal may be an alloy of lithium and a metal selected from Na, K, Rb, Cs, Fr, Be, Mg, Ca, Sr, Si, Sb, Pb, In, Zn, Ba, Ra, Ge, Al, and Sn.

An Si-based negative electrode active material or an Sn-based negative electrode active material may be used as the material capable of doping and dedoping lithium. The Si-based negative electrode active material may be silicon, a silicon-carbon composite, SiOₓ (0<x<2), an Si-Q alloy, or a combination thereof. In the formula Si-Q, Q is selected from an alkali metal, an alkaline earth metal, a group 13 element, a group 14 element (excluding Si), a group 15 element, a group 16 element, a transition metal, a rare earth element, and a combination thereof. The Sn-based negative electrode active material may be Sn, SnO₂, an Sn-based alloy, or a combination thereof.

The silicon-carbon composite may be a composite of silicon and amorphous carbon. According to an embodiment, the silicon-carbon composite may be in the form of silicon particles whose surfaces are coated with amorphous carbon. For example, the silicon-carbon composite may include a secondary particle (core) in which silicon primary particles are assembled and an amorphous carbon coating layer (shell) located on the surface of the secondary particle. The amorphous carbon may also be located between the silicon primary particles, and the silicon primary particles may be, for example, coated with amorphous carbon. The secondary particles may be dispersed in an amorphous carbon matrix.

The silicon-carbon composite may further include crystalline carbon. For example, the silicon-carbon composite may include a core containing crystalline carbon and silicon particles and an amorphous carbon coating layer located on the surface of the core.

The Si-based negative electrode active material or Sn-based negative electrode active material may be used in combination with a carbon-based negative electrode active material.

The second active material layer may further include a negative electrode conductive material and a negative electrode binder.

The negative electrode conductive material is used to impart conductivity to the second active material layer, and any material may be used as the negative electrode conductive material so long as it does not cause chemical changes in the battery and is electronically conductive. Examples of negative electrode conductive materials include carbon-based materials such as natural graphite, artificial graphite, carbon black, acetylene black, Ketjen black, carbon fibers, carbon nanofibers, and carbon nanotubes, metal-based materials in the form of metal powder or metal fibers containing copper, nickel, aluminum, silver, etc., conductive polymers such as polyphenylene derivatives, or a mixture thereof.

The negative electrode binder serves to adhere the particles constituting the negative electrode active material to each other and also to adhere the negative electrode active material to the second electrode plate 120. The negative electrode binder may be, for example, a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When an aqueous binder is used as the negative electrode binder, it may further include a cellulose-based compound capable of imparting viscosity. As the cellulose-based compound, a mixture of one or more of carboxymethyl cellulose, hydroxypropylmethyl cellulose, methyl cellulose, or alkali metal salts thereof may be used. As the alkali metal, Na, K, or Li may be used.

A dry binder is a polymer material capable of being fiberized, and may be, for example, polytetrafluoroethylene, polyvinylidene fluoride, a polyvinylidene fluoride-hexafluoropropylene copolymer, polyethylene oxide, or a combination thereof.

The second electrode plate 120 may include a second uncoated portion 121 where the second active material layer is not applied. The second uncoated portion 121 may protrude a predetermined distance from a second end of the electrode assembly 100 located on the opposite side of the first uncoated portion 111 in the direction of the winding axis C.

A separator 130 may be disposed between the first electrode plate 110 and the second electrode plate 120. The separator 130 may allow the movement of lithium ions between the first electrode plate 110 and the second electrode plate 120 while preventing a short circuit between the first electrode plate 110 and the second electrode plate 120. As the separator 130, polyethylene, polypropylene, polyvinylidene fluoride, or a multilayer film of two or more layers thereof may be used, and mixed multilayer films such as a polyethylene/polypropylene two-layer separator, a polyethylene/polypropylene/polyethylene three-layer separator, a polypropylene/polyethylene/polypropylene three-layer separator, etc. may be used.

The separator 130 may include a porous substrate. A coating layer including an organic material, an inorganic material, or a combination thereof may be provided on one or both sides of the porous substrate. The porous substrate may be a polymer film formed of one polymer selected from polyolefins such as polyethylene, polypropylene, etc., polyesters such as polyethylene terephthalate, polybutylene terephthalate, etc., polyacetal, polyamide, polyimide, polycarbonate, polyetherketone, polyaryletherketone, polyetherimide, polyamideimide, polybenzimidazole, polyethersulfone, polyphenylene oxide, a cyclic olefin copolymer, polyphenylene sulfide, polyethylene naphthalate, glass fiber, Teflon, and polytetrafluoroethylene, or a copolymer or mixture of two or more thereof. The organic material may include a polyvinylidene fluoride-based polymer or a (meth)acrylic polymer. The inorganic material may include inorganic particles selected from Al₂O₃, SiO₂, TiO₂, SnO₂, CeO₂, MgO, NiO, CaO, GaO, ZnO, ZrO₂, Y₂O₃,SrTiO₃, BaTiO₃, Mg(OH)₂, boehmite, and combinations thereof, but is not limited thereto.

The organic material and the inorganic material may be present as a mixture in one coating layer or as a coating layer including an organic material and a coating layer including an inorganic material with the two coating layers being stacked.

The separator 130 may be provided as a pair. A pair of separators 130 may be disposed to face both sides of the first electrode plate 110 or the second electrode plate 120. The pair of separators 130 may be wound together with the first electrode plate 110 and the second electrode plate 120 around the winding axis C.

The case 200 according may form the general outer shape of the secondary battery 2 and accommodate the electrode assembly 100. The case 200 may be electrically conductive. In some examples, the case 200 may include at least one material of steel, stainless steel, aluminum, and an aluminum alloy. The case 200 may include a can 201, an open portion 202, and a sealing portion 203.

The can 201 may be cylindrically shaped with a circular cross-section. The diameter of the can 201 may be larger than the diameter of the electrode assembly 100. The length of the can 201 in the direction of the winding axis C of the electrode assembly 100 may be greater than the length of the electrode assembly 100.

The electrode assembly 100 may be accommodated in the can 201. The central axis of the can 201 may be coaxial with the winding axis C of the electrode assembly 100.

The open portion 202 and the sealing portion 203 may be disposed at each end of the can 201. The open portion 202 and the sealing portion 203 may be spaced apart from each other along a first direction. The first direction described below may refer to the direction of the central axis of the can 201 and the winding axis C of the electrode assembly 100, specifically the direction from the open portion 202 toward the sealing portion 203, which is the z-axis direction shown in FIG. 5.

The open portion 202 according to the present embodiment may be a hole passing through one end of the can 201. Both sides of the open portion 202 may be connected to the space inside and outside the can 201. During the manufacturing process of the secondary battery 2, the electrode assembly 100 and an electrolyte may be inserted into the can 201 through the open portion 202.

The sealing portion 203 may be formed as a circular plate disposed at an opposite end of the can 201 that is spaced apart from the open portion 202 along the first direction. The outer surface of the sealing portion 203 may be integrally formed with the inner surface of the can 201 to seal the end of the can 201. For example, the can 201 and the sealing portion 203 may be formed by a deep drawing process. Alternatively, the sealing portion 203 may be manufactured separately from the can 201 and its outer surface may be joined to the inner surface of the can 201. A through-hole may be formed in the center of the sealing portion 203 to provide a path for inserting the terminal 400 (which will be described below).

The first uncoated portion 111 of the electrode assembly 100 may be disposed in the can 201 to face the sealing portion 203. The second uncoated portion 121 of the electrode assembly 100 may be disposed in the can 201 to face the open portion 202.

A case gasket G3 that electrically insulates the electrode assembly 100 from the sealing portion 203 may be disposed between the electrode assembly 100 and the sealing portion 203. The case gasket G3 may function to electrically insulate the electrode assembly 100 from the sealing portion 203 by preventing direct contact between the case 200 and the first electrode plate 110. The case gasket G3 may be disposed between one side of the electrode assembly 100 where the first uncoated portion 111 protrudes and the inner surface of the sealing portion 203 that faces the internal space of the can 201. The case gasket G3 may be fixed to the inner surface of the sealing portion 203 using an adhesive and the like. The case gasket G3 may be composed of an insulating material such as rubber, polyethylene (PE), polypropylene (PP), polyethylene terephthalate (PET), and the like.

The case 200 according to the present embodiment may further include a beading portion 204. The beading portion 204 refers to a portion of the can 201 that protrudes from the inner surface of the can 201 toward the central axis of the can 201. The beading portion 204 may be formed by pressing the outer circumference of the can 201 adjacent to the open portion 202. The beading portion 204 may come into contact with the end of the electrode assembly 100 where the second uncoated portion 121 protrudes. Accordingly, the beading portion 204 may prevent the electrode assembly 100 from moving in the can 201 or being separated from the can 201.

The cap assembly 300 according to the present embodiment may include a cap plate 301. The cap plate 301 may be configured to seal the open portion 202 of the case 200. The cap plate 301 may be a circular plate. The cap plate 301 may be disposed in the can 201. In particular, the cap plate 301 may be disposed in the can 201 to face the end of the electrode assembly 100 with the beading portion 204 therebetween. One side of the cap plate 301 may be seated on the beading portion 204. The other side of the cap plate 301 may be disposed to face the space outside the can 201.

A crimping portion 205 for fixing the cap plate 301 may be formed at one end of the can 201 where the open portion 202 is formed. The crimping portion 205 may be bent from one end of the can 201 and disposed to face the r side of the cap plate 301 that is disposed to face the space outside the can 201.

A cap gasket G1 that electrically insulates the cap plate 301 from the case 200 may be disposed between the cap plate 301 and the crimping portion 205. The cap gasket G1 may be disposed to completely surround the end of the cap plate 301. The outer surface of the cap gasket G1 may be pressed and fixed to the inner surfaces of the beading portion 204 and the crimping portion 205. The cap gasket G1 may be composed of an insulating material such as rubber, polyethylene (PE), polypropylene (PP), polyethylene terephthalate (PET), and the like. Accordingly, the cap gasket G1 may electrically insulate the cap plate 301 from the case 200 and prevent moisture, foreign substances, etc. from entering between the cap plate 301 and the case 200.

The crimping portion 205 may be disposed to face the other side of the cap plate 301 with the cap gasket G1 therebetween. And the crimping portion 205 may come into contact with the cap gasket G1 to press the cap plate 301 toward the beading portion 204. Accordingly, the cap plate 301 may be stably fixed at the open portion 202 side of the case 200.

The cap plate 301 may be composed of a metal material to ensure mechanical rigidity, or alternatively, may be composed of a non-electrically conductive synthetic resin material.

The cap assembly 300 according to the present embodiment may be provided with a vent 302 that opens the cap plate 301 when the internal pressure of the case 200 exceeds a set pressure. The vent 302 may be thinner than other areas of the cap plate 301. For example, the vent 302 may be a notch concavely formed in a side of the cap plate 301. The vent 302 may be spaced apart from the center of the cap plate 301 and have a ring shape that is concentric with the ends of the cap plate 301. As another example, the vent 302 may have at least one pattern that is a straight or curved shape.

The terminal 400 is coupled to the case 200 and may be electrically connected to the electrode assembly 100 via the first current collector 500 (which will be described below). The terminal 400 may be composed of an electrically conductive metal material such as aluminum, nickel, and copper. More specifically, the terminal 400may be electrically connected to the first electrode plate 110 of the electrode assembly 100 via the first current collector 500. The terminal 400 may thereby function as a positive electrode terminal of the secondary battery 2. However, the terminal 400 is not limited thereto and may be a negative electrode terminal by being electrically connected to the second electrode plate 120.

The terminal 400 according to the present embodiment may pass through the sealing portion 203 of the case 200 along the first direction. More specifically, the terminal 400 may be inserted into the through-hole formed in the center of the sealing portion 203. The outer surface of the terminal 400 may be spaced from the inner surface of the through-hole formed in the center of the sealing portion 203. One end of the terminal 400 may be disposed in the space inside the can 201 and another end of the terminal 400 may be disposed outside of the can 201.

The ends of the terminal 400 disposed in the space inside and outside the can 201 may be compressed and deformed by riveting and disposed to face the outer and inner surfaces of the sealing portion 203, respectively. Accordingly, the edge area of the terminal 400 may have a cross-sectional shape that is approximately U-shaped. Thus, the terminal 400 may be stably fixed to the case 200 while passing through the sealing portion 203.

On one side of the terminal 400 located in the can 201, a first terminal surface 401 facing the electrode assembly 100 along the first direction may be formed. The first terminal surface 401 may have a planar shape disposed perpendicular to the first direction. On the other side of the terminal 400 located outside the can 201, a second terminal surface 402 spaced apart from the first terminal surface 401 along the first direction may be formed. The second terminal surface 402 may have a planar shape that faces the space outside the can 201 and is parallel to the first terminal surface 401. The terminal 400 may have a structure with different cross-sectional areas on both sides based on the sealing portion 203.

A terminal gasket G2 that electrically insulates the terminal 400 from the case 200 may be disposed between the terminal 400 and the case 200. The terminal gasket G2 may be disposed to completely surround the inner surface of the through-hole formed in the sealing portion 203 and the outer surface of the sealing portion 203 facing both ends of the terminal 400. Both surfaces of the terminal gasket G2 may be in contact with the surfaces of the sealing portion 203 and the terminal 400. The terminal gasket G2 may be composed of an insulating material such as rubber, polyethylene (PE), polypropylene (PP), polyethylene terephthalate (PET), and the like.

The first current collector 500 may be disposed between the electrode assembly 100 and the first terminal surface 401, and the first current collector 500 may be connected to the electrode assembly 100. The first current collector 500 may be composed of an electrically conductive metal material such as aluminum, nickel, copper, and the like.

The first current collector 500 may be disposed between one side of the electrode assembly 100 where the first uncoated portion 111 protrudes and the first terminal surface 401. The first current collector 500 may be connected to the first terminal surface 401 and the first uncoated portion 111. Accordingly, the first current collector 500 may serve to electrically connect the electrode assembly 100 and the terminal 400. In an embodiment, the first current collector 500 may serve as a positive electrode current collector.

The secondary battery 2 may further include a second current collector 600. The second current collector 600 may be disposed between the electrode assembly 100 and the cap plate 301, and the second current collector 600 may be connected to the electrode assembly 100. The second current collector 600 may be composed of an electrically conductive metal material such as aluminum, nickel, copper, and the like. The second current collector 600 may include a flat portion 610 that faces the other side of the electrode assembly 100 where the second uncoated portion 121 protrudes and an extending portion 620 that extends from the flat portion 610.

One side of the flat portion 610 that faces the other side of the electrode assembly 100 may be connected to the second uncoated portion 121. Accordingly, the second current collector 600 may function as a negative electrode current collector. The end of the second uncoated portion 121 may be bent in a direction parallel to the flat portion 610 and may be connected to one side of the flat portion 610 by welding and the like. The bending direction of the second uncoated portion 121 may be directed toward the winding axis C of the electrode assembly 100.

The extending portion 620 may extend from the edge of the flat portion 610 toward the cap plate 301. The extending portion 620 may come contact the inner surface of the beading portion 204. The extending portion 620 may be rounded or bent along the beading portion 204. The extending portion 620 may be connected to the beading portion 204 by welding and the like. With such a configuration, the case 200 and the second electrode plate 120 may be electrically connected, and the sealing portion 203 may function as a negative electrode terminal.

A plurality of extending portions 620 may be formed. The extending portions 620 may be spaced apart from each other along the edge of the flat portion 610. However, the secondary battery 2 according to the present embodiment is not limited to such a configuration, and it is also possible for the second uncoated portion 121 of the electrode assembly 100 to be directly connected to the cap plate 301.

In the secondary battery 2 according to the present embodiment, after inserting the jelly roll of the electrode assembly 100 into the can 201, the terminal 400, the first current collector 500, and the second current collector 600 may be welded, and the fire extinguishing agent structure 700 may be mounted before forming the crimping portion 205. The disk-shaped member 701 of the fire extinguishing agent structure 700 may be seated between the electrode assembly 100 and the cap assembly 300, and the stick-shaped member 702 may be inserted into the winding core of the electrode assembly 100.

Hereinafter, battery packs according to various embodiments of the present disclosure will be described.

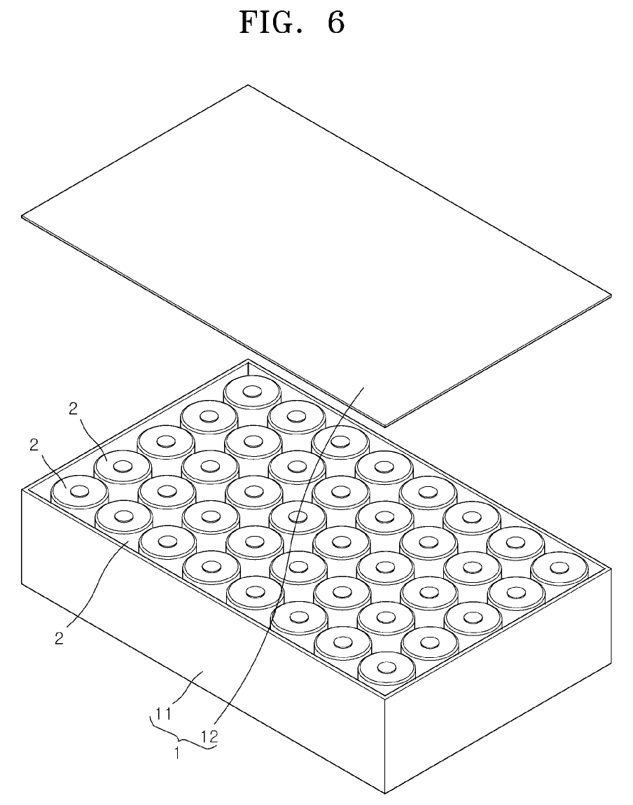

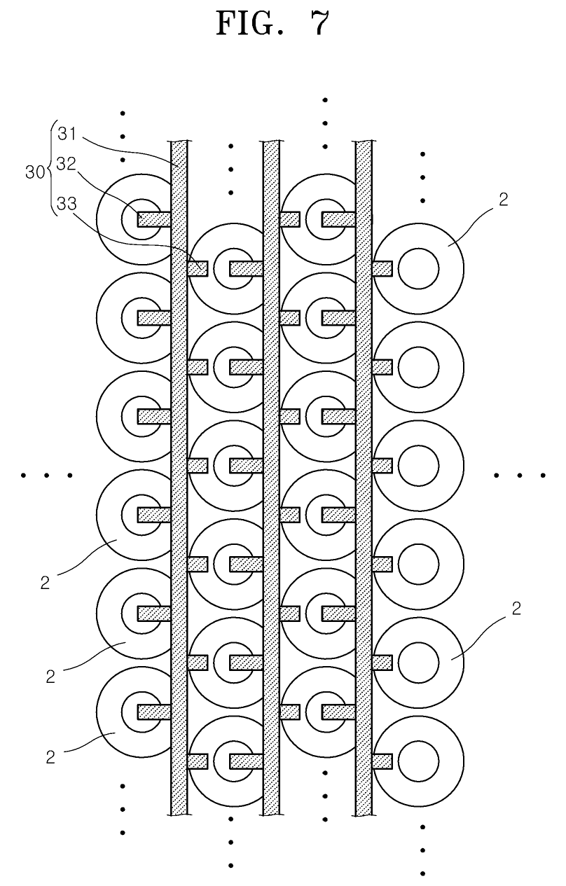

FIG. 6 is a perspective view schematically illustrating the configuration of a battery pack according to an embodiment of the present disclosure, and FIG. 7 is a plan view schematically illustrating the configuration of a battery pack according to an embodiment of the present disclosure.

Referring to FIGS. 6 and 7, the battery pack according to various embodiments may include a housing 1 and secondary batteries 2. The housing 1 may form the outer shape of the battery pack and provide a space for accommodating the secondary batteries 2. The housing 1 according to the present embodiment may include a housing body 11 and a cover 12.

The housing body 11 may be formed as a box with an open side and an empty interior. The cross-sectional shape of the housing body 11 is not limited to the rectangular shape shown in FIG. 1 and may be various other shapes such as polygonal, circular, and oval shapes.

The cover 12 may be coupled to the housing body 11 and may seal the internal space of the housing body 11. For example, the cover 12 may have a plate-like shape and may be disposed to face the open side of the housing body 11. The cover 12 may be fixed to the housing body 11 by various joining methods such as bolting, welding, and fitting.

The secondary battery 2 may be disposed in the housing 1. The secondary battery 2 may be any of the secondary batteries according to the embodiments described above.

A plurality of secondary batteries 2 may be provided. The plurality of secondary batteries 2 may be disposed in various patterns such as a lattice or zigzag in the housing 1. The plurality of secondary batteries 2 may be arranged side by side. The number of secondary batteries 2 vary depending on the size and shape of the housing 1.

According to the present disclosure, it is possible to increase the efficiency of the endothermic reaction of the fire extinguishing agent and prevent thermal runaway at high temperatures by including the fire extinguishing agent structure.

According to the present disclosure, it is possible to reduce the risk of ignition or explosion of the battery and improve stability.

However, the effects that can be achieved through the present disclosure are not limited to the above-described effects, and other technical effects not mentioned can be clearly understood by those skilled in the art from the above description of the disclosure.

The present disclosure has been described with reference to the embodiments illustrated in the drawings, but these embodiments are merely exemplary, and those skilled in the art to which the present disclosure pertains will understand that various modifications and equivalent other embodiments are possible therefrom.

### List of Reference Numerals

1: Housing 2: Secondary battery

11: Housing body 12: Cover

100: Electrode assembly 110: First electrode plate

111: First uncoated portion 120: Second electrode plate

121: Second uncoated portion 130: Separator

200: Case 201: Can

202: Open portion 203: Sealing portion

204: Beading portion 205: Crimping portion

300: Cap assembly 301: Cap plate

302: Vent 400: Terminal

401: First terminal surface 402: Second terminal surface

500: First current collector 600: Second current collector

700: Fire extinguishing agent structure 701: Disk-shaped member

702: Stick-shaped member 703: Polymeric cover member

704: Microcapsule 705: Fire extinguishing agent

What is claimed is:

1. A fire extinguishing agent structure comprising:
a disk-shaped member; and
a stick-shaped member connected to and extending perpendicular to the disk-shaped member,
wherein the stick-shaped member and the disk-shaped member include a fire extinguishing agent that causes an endothermic reaction at a temperature of 100 °C or higher.

2. The structure of claim 1, wherein the fire extinguishing agent is contained in microcapsules.

3. The structure of claim 2, wherein the microcapsules melt at a temperature of 100 °C or higher and release the fire extinguishing agent contained therein upon melting.

4. The structure of claim 2, wherein the microcapsules have a diameter of 10 μm to 30 μm.

5. The structure of claim 1, wherein the fire extinguishing agent is one or more of sodium bicarbonate (NaHCO₃), potassium bicarbonate (KHCO₃), manganese carbonate (MnCO₃), and ammonium dihydrogen phosphate (NH₄H₂PO₄).

6. The structure of claim 1, wherein the disk-shaped member and the stick-shaped member are integrally formed.

7. The structure of claim 1, wherein the disk-shaped member and the stick-shaped member are filled with microcapsules containing the fire extinguishing agent.

8. The structure of claim 1, wherein the disk-shaped member and the stick-shaped member are formed from a composition including microcapsules containing the fire extinguishing agent and a binder.

9. The structure of claim 1, wherein the disk-shaped member and the stick-shaped member include a polymeric cover member and microcapsules contained in the polymeric cover member, with the microcapsules containing the fire extinguishing agent, and
wherein the polymeric cover member is configured to melt or rupture at a temperature of 100 °C or higher.

10. The structure of claim 1, wherein the disk-shaped member has a diameter of 30 mm to 45 mm and a thickness of 1.0 mm to 5.0 mm.

11. The structure of claim 1, wherein the stick-shaped member has a diameter of 3 mm to 6 mm and a length of 0.55 to 0.96.

12. A secondary battery comprising the fire extinguishing agent structure of claim 1.

13. The secondary battery of claim 12, wherein the disk-shaped member is seated between an electrode assembly and a cap assembly, and the stick-shaped member is inserted into a core of the electrode assembly.

14. A secondary battery comprising:
an electrode assembly;
a case accommodating the electrode assembly;
a cap assembly electrically connected to the electrode assembly;
a disk-shaped member positioned between the electrode assembly and the cap assembly; and
a stick-shaped member connected to and extending perpendicular to the disk-shaped member, the stick-shape member being inserted into a core of the electrode assembly,
wherein the disk-shaped member and the stick-shaped member include a fire extinguishing agent that causes an endothermic reaction at a temperature of 100 °C or higher.

15. The secondary battery of claim 14, wherein the fire extinguishing agent is contained in microcapsules.

16. The secondary battery of claim 15, wherein the microcapsules have a diameter of 10 μm to 30 μm.

17. The secondary battery of claim 14, wherein the fire extinguishing agent is one or more of sodium bicarbonate (NaHCO₃), potassium bicarbonate (KHCO₃), manganese carbonate (MnCO₃), and ammonium dihydrogen phosphate (NH₄H₂PO₄).

18. The secondary battery of claim 14, wherein the disk-shaped member and the stick-shaped member include a polymeric cover member and microcapsules contained in the polymeric cover member, with the microcapsules containing the fire extinguishing agent, and
wherein the polymeric cover member is configured to melt or rupture at a temperature of 100 °C or higher.

19. The secondary battery of claim 14, wherein the disk-shaped member has a diameter of 30 mm to 45 mm and a thickness of 1.0 mm to 5.0 mm.

20. The secondary battery of claim 14, wherein the stick-shaped member has a diameter of 3 mm to 6 mm and a length of 0.55 to 0.96.
